(19) United States
(12) Patent Application Publication
(10) Pub. No.: US 2009/0299837 A1
(43) Pub. Date: Dec. 3, 2009

(54) System and method for brand affinity content distribution and optimization

(76) Inventors: Ryan Steelberg, Irvine, CA (US); Chad Steelberg, Newport Beach, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 12/454,386

(22) Filed: May 15, 2009

Related U.S. Application Data
(63) Continuation-in-part of application No. 12/220,912, filed on Jul. 29, 2008.
Application No. 12/220,912 is a continuation-in-part of application No. 12/144,194, filed on Jun. 23, 2008.
Application No. 12/144,194 is a continuation-in-part of application No. 11/981,837, filed on Oct. 31, 2007.

(51) Int. Cl. G06Q 30/00; G06N 5/02

(52) U.S. Cl. 705/14.4; 706/47

(57) ABSTRACT

An endorsed advertising engine, system and method, which includes at least one vault having media assets, a recommendation engine that matches the media assets from the vault with at least one requested creative, and a delivery engine that integrates the requested creative with the matched media assets from the vault.

### CROSS-REFERENCE TO RELATED APPLICATIONS

This application is a continuation-in-part of U.S. patent application Ser. No. 12/220,912, entitled “System And Method For Content Distribution And Optimization,” filed Jul. 29, 2008 (which is a continuation-in-part of U.S. patent application Ser. No. 12/144,194, entitled “System and Method for Brand Affinity Content Distribution and Optimization”, filed Jun. 23, 2008);

and is a continuation-in-part of U.S. patent application Ser. No. 11/981,837 entitled “An Advertising Request And Rules-Based Content Provision Engine, System and Method”, filed Oct. 31, 2007.

U.S. patent application Ser. No. 12/144,194 is: a continuation-in-part of U.S. patent application Ser. No. 11/981,646, entitled “Engine, System and Method for Generation of Brand Affinity Content”, filed Oct. 31, 2007; a continuation-in-part of U.S. patent application Ser. No. 11/981,837, entitled “An Advertising Request And Rules-Based Content Provision Engine, System and Method”, filed Oct. 31, 2007; a continuation-in-part of U.S. patent application Ser. No. 10/072,692, entitled “Engine, System and Method For Generation of Brand Affinity Content, filed Feb. 27, 2008; and a continuation in part of U.S. patent application Ser. No. 12/079,769, entitled “Engine, System and Method for Generation of Brand Affinity Content,” filed Mar. 27, 2008.

U.S. patent application Ser. No. 11/981,837 claims priority to U.S. Provisional Application Ser. No. 60/993,096, entitled “System and Method for Rule Based Generation of Brand Affinity Content,” filed Sep. 7, 2007, and is related to U.S. patent application Ser. No. 11/981,646.

Each of the above-referenced applications are hereby incorporated by reference herein as if set forth in the entirety.

### FIELD OF THE INVENTION

The present invention is directed to an advertising engine and, more particularly, to an engine for generation of brand affinity content, and a method of making and using same.

### BACKGROUND OF THE INVENTION

High impact advertising is that advertising that best grabs the attention of a target consumer. A target consumer is the ideal customer for the particular goods being advertised, from a socioeconomic perspective, from a morals and values perspective, from an age or interest level perspective, or based on other similar factors. The impact on an ideal customer of any particular advertisement may be improved if an advertisement includes endorsements, sponsorships, or affiliations from those persons, entities, or the like from whom the ideal target consumer is most likely, or highly likely, to seek guidance. Factors that will increase the impact of an endorser include the endorser's perceived knowledge of particular goods or in a particular industry, the fame or popularity of the endorser, the respect typically accorded a particular endorser or sponsor, and other similar factors.

Consequently, the highest impact advertising time or block available for sale will generally be time that is associated, such as both within the advertisement and within the program with which the advertisement is associated, with an endorser most likely to have high impact on the ideal target customer. However, the existing art makes little use of this advertising reality.

Thus, there exists a need for an engine, system and method that allows for the obtaining of an endorsement or sponsorship, in the aforementioned high-impact circumstances, either from a specific individual, a specific entity, an affinity brand, a marketing partner, or a sponsor.

### SUMMARY OF THE INVENTION

The present invention includes at least an endorsed advertising engine, system and method, which includes at least one vault having media assets, a recommendation engine that matches the media assets from the vault with at least one requested creative, and a delivery engine that integrates the requested creative with the matched media assets from the vault.

Thus, the present invention provides an engine, system and method that allows for the obtaining of an endorsement or sponsorship, in the aforementioned high-impact circumstances, either from a specific individual, a specific entity, an affinity brand, a marketing partner, or a sponsor.

### BRIEF DESCRIPTION OF THE FIGURES

The present invention will be described hereinbelow in conjunction with the following figures, in which like numerals represent like items, and wherein:

FIG. 1 illustrates an exemplary embodiment of the present invention;

FIG. 2 illustrates an exemplary embodiment of the present invention;

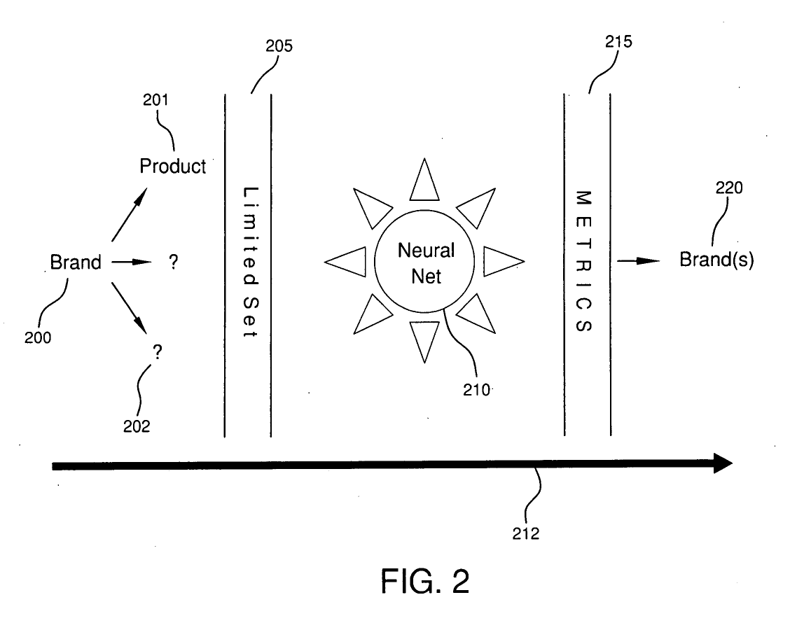

FIG. 3 illustrates an exemplary embodiment of the present invention;

FIG. 4 illustrates an exemplary embodiment of the present invention;

FIG. 5 illustrates an exemplary embodiment of the present invention;

FIG. 6 illustrates an exemplary embodiment of the present invention; and

FIG. 7 illustrates an exemplary embodiment of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical advertising engines, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

It is generally accepted that advertising (hereinafter also referred to as “ad” or “creative”) having the highest impact on the desired consumer base includes endorsements, sponsorships, or affiliations from those persons, entities, or the like from whom the targeted consumers seek guidance, such as based on the endorser's knowledge of particular goods or in a particular industry, the fame of the endorser, the respect typically accorded a particular endorser or sponsor, and other similar factors. Additionally, the easiest manner in which to sell advertising time or blocks of advertising time is to relay to a particular advertiser that the advertising time purchased by that advertiser will be used in connection with an audio visual work that has an endorsement therein for that particular advertiser's brand of goods or services. As used herein, such an endorsement may include an assertion of use of a particular good or service by an actor, actress, or subject in the audio visual work, reference to a need for a particular types of goods or services in the audio visual work, or an actual endorsement of the use of a product within the audio visual work.

Endorsements may be limited in certain ways, as will be apparent to those skilled in the art. Such limitations may include geographic limitations on the use of particular products (endorsers are more likely to endorse locally in various locales rather than nationally endorse, in part because national endorsements bring a single endorsement fee and generally preclude the repetitious collection of many smaller fees for many local endorsements), or limitations on the use of endorsements in particular industries, wherein a different product or a different industry may be endorsed (such as in a different geographical area) by the same endorser, or limitations on endorsements solely to a particular field(s) or type(s) of product, rather than to a specific brand of product. Further, endorsements by particular endorsers may be limited to products, brands or products or services, types of products or services, or the like which are approved by one or more entities external from, but affiliated with, the specific endorser. For example, the National Football League may allow for its players only to endorse certain products, brands of products, types of products, or the like, that are also endorsed by the NFL.

More specifically, as used herein endorsements may include: endorsements or sponsorships, in which an individual or a brand may be used to market another product or service to improve the marketability of that other product or service; marketing partnerships, in which short term relationships between different products or services are employed to improve the marketing of each respective product or service; and brand affinity, which is built around a long term relationship between different products or services such that, over time, consumers come to accept an affinity of one brand based on its typical placement with another brand in another industry.

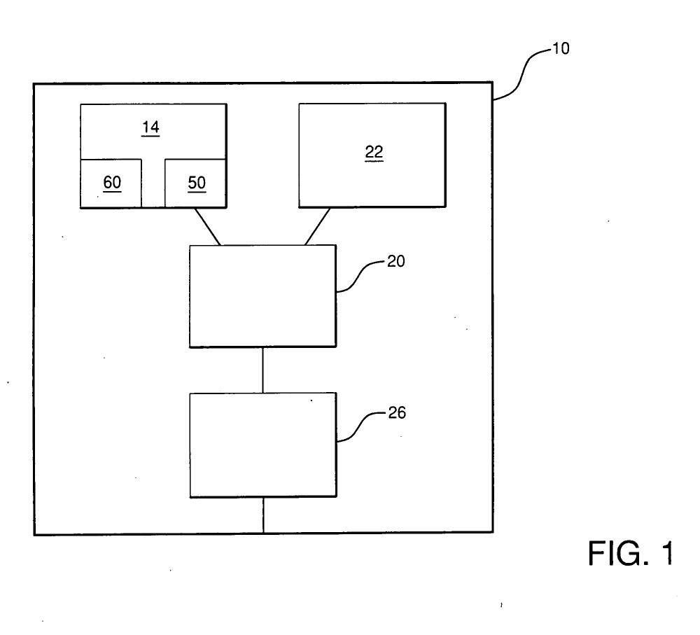

At present, there is a need for a platform or engine to allow for the obtaining of an endorsement, or endorsed ad, in any of the above circumstances, either from a specific individual, a specific entity, an affinity brand, a marketing partner, or a sponsor. In the present invention, an endorsed advertising engine 10, such as that illustrated in FIG. 1, may include a vault. 12 that provides media assets 14 and integration of media assets without need of involving the media assets for permission, a brand association or recommendation engine 20 that may, by creative, by market, by brand affinity, by user request, or otherwise match media assets from the vault with an creative/ad 22, and a delivery engine 26 capable of integrating a requested ad 22 with the media asset 14 from the vault 12, late stage binding of the ad 22 and media asset 16 upon delivery to strongest target consumers, and delivery of the ad 22 and the dynamic media asset 16 from the vault to an advertiser or advertising server, which then places the mash up of the ad and media asset. Ad requests 22 may be made via an “ad wizard” using ad templates, as will be apparent to those skilled in the art.

The vault captures certain brands and information related thereto in a common database, such as all major league baseball past and present players, including statistics, video, and pictures of those players affiliated with the names of those players, in addition to any endorsement limitations on those players. The vault may include media assets that may be associated with audio-visual works. The vault may include symbols, emblems, taglines, pictures, video, press releases, publications, web links, web links to external content, and media capable of re-purposing (such as an athlete running in front of a blue screen, wherein the athlete may be re-purposed by the placement of a background over the blue screen), including pictures, voice, and video. The vault may also include, associated with the brand, exclusion, inclusions, or preferences 50 for the use of the brand or particular items of information associated with the brand in the vault. Such inclusions, exclusions, or preferences may include geographic limitations on certain information items or endorsements, product limitations, preferred partners or products or product types for endorsement, etc. Exclusions may, of course, be necessary if the requested endorsement conflicts with a pre-existing endorsement agreement for the requested brand with a competitor, or the like.

Further, media assets in the vault may be marked with different payment schema 52 based on the requester of the media asset. For example, in the event the ad requester is a school, and the requested creative is not an ad to sell anything, media assets may be available for use for free. Such exceptions may be made, with regard to payment, with regard to any level of payment variation as between any number of different user types, such as non-profit, for-profit, individual, corporate, in-home, in-business, and the like. Additionally, for example, icons of a favorite football player may be requested by a non-profit individual for at-home use, to be overlayed over a live football program then on that individual's television, at no charge to that individual.

The brand association and recommendation engine 20 assesses, based on numerous factors including external factors, the endorsements that are most sensible for particular advertising. For example, such a brand association engine gauges proper matches by assessing inclusions and exclusions based on the aforementioned factors in the vault, such as geography, but additionally can use stored or external information and/or variable factoring to do brand associations for any two brands (such as wherein brand associations already exhibiting brand affinity would have the highest percentage association, and brands which would make the most sensible association would also exhibit higher percentage matching for brand association), or to do matching with an endorsement brand based on the target consumers of the requesting brand.

For example, a “profile” 60 may be developed in the vault for a particular brand. Such a profile may include any of a myriad of information, both stored in the vault and having external references outside the vault from within the vault, including but not limited to psychological profiles of typical users of that brand (which may include values, motivations, wants, and needs of such users, and which may be assessed based on inferences from on-line, credit card, or television use by those users, for example), brand profiles including target customers, target affiliate profiles (which may include reasons for desired affiliation, such as sharing marketing costs, increasing brand recognition in certain geographies or fields of use, distribution channel access, expedited market entry, or improved brand perception, for example), and the like, and such profiles may be used as media assets by the recognition engine in order to develop a best match. As an additional example, polling may provide for local or national focus and maintained in the vault as an associated media asset with a particular brand, and best matches for certain brands may be selected according to such polling results. For example, a “flashy” sports personality may be a best match for a brand offering in Los Angeles, but a different athlete's endorsement might be preferably to sell that brand in the mid-west. Such information, including “who's hot”, or where a brand is “hot”, may be associated with the media assets regarding that brand in the vault, and may be thus used by the recommendation engine to do matching.

Thus, the recommendation engine may passively or actively inform of the best endorsement matches for a particular user's ads, based on any number of factors. Upon assessment of good matches for the requesting brand, a user of the present invention may have the matching options presented to that user for selection by the recommendation engine, or the user may simply have a best-match selection made for the user. Needless to say, bids for advertising may vary based on the matches obtained by the recommendation engine, and/or the asserted likelihood of success that the ad placed will be successful. Success, of course, may be different in different circumstances, and may include a consumer making an on-line or in-store purchase, a user filling out an on-line or off-line form, a consumer accessing and downloading information or a coupon, or the like.

The delivery engine 26 may integrate a requested ad with the media asset from the vault pursuant to the actions by the recommendation engine, and can place a particular ad in the environment it deems best suited for that ad (such as in the event of a re-direct, wherein a web site gives some information about an ad request, and the best ad can be placed responsive to the ad request), late stage bind the ad and media asset for delivery to strongest target consumers (such as with the improvement in later stage tracking for improved ad targeting, such as if the consumer's requesting IP address and/or the referring site information is available just prior to ad delivery), or deliver the static ad and the dynamic media asset from the vault to an advertiser or advertising server, which then independently places the mash up of the ad and media asset. Needless to say, bids for advertising time may vary depending upon the delivery mechanism used.

Improvement in later stage tracking for improved ad targeting may be enabled through the delivery engine 26 and will allow for greater efficiency the trafficking of ads during or after or with or without interface with the delivery engine 26. Efficiency may be obtained by tracking, for example, the data intelligence for use with the delivery of the creative. By way of non-limiting example, data intelligence may include click-thru rate, post-click conversion rate, post-impression activities, as well as geography, demographic and like information. Gathered data intelligence may be used as individual properties in conjunction with each other to form or produce the level of intelligence needed to achieve the desired efficiencies. By way of further example, data intelligence may also include information regarding the number of impressions an ad has received, the elapsed time between an impression or a click.

Utilizing the data intelligence will allow the delivery engine 26 to optimize targeting to new and past targets. Optimization may include efficiencies of time and control over redundancies and ad targeting. Optimization will allow for the prediction of probable impressions or clicks that a certain ad or creative may receive when, for example, pointed towards certain factors, such as demographic and geography, for example. A prediction may also be made regarding the efficiency of paid searches and may be further contrasted with, for example, display ads. Such information as drawn from the data intelligence may also allow for the higher success rates related to redundant ad placement based on the prior behavior of a particular audience. The same can be true for the avoidance of redundancy when, for example, data intelligence may be used to keep certain ads or creatives from repeatedly reaching an audience with, for example, low click-through rates. Redundancy avoidance may also include the avoidance of competing ads or creatives, whether or not placed for the same entity.

The delivery engine 26 may also choose to deactivate and/or modify certain creatives based on data intelligence and/or user direction. By way of non-limiting example, the data intelligence may be collected from several ad or creative types over any number of varying media formats, allowing for even more sophisticated optimization based on the allocation of impressions and clicks in the various media formats. Media formats may include, but are not limited to, internet, t.v., radio, mobile devices, kiosks, billboards, product placements, and print. By further way of non-limiting example, data intelligence gathered during a run of a creative on the radio may effect the play of an ad on the internet. The delivery engine 26 may additionally allow for the interplay between data intelligence and real time metrics or community-based information. This real time intelligence gathering may also be used to calibrate a campaign(s) of multiple ads or creatives. By way of non-limiting example only, a campaign of with several creative versions may be measured based on gathered data intelligence and optimized to improve, for example, click-through. Such optimization may be done in real time and over multiple media types. The optimization may, by way of further non-limiting example, call for the addition of ads or creatives not currently apart of the campaign(s). Thus suggesting what type of ads or creatives are required for maximum optimization regardless of whether or not the ads or creatives reside in inventory.

Optimization of ads and creatives increases the value of ad and creative inventory and may, for example, provide for greater value pre and post delivery. The data intelligence may also allow for real-time valuations based on pre-existing and predicted variables, thus maximizing the value of the placed ad or ad/creative inventory. Value can be also maximized for premium and non-premium content. Functionality within the delivery engine 26 may also allow for variable rate sampling and frequency cap forecasting.

Because the bids for advertising time in the present invention may vary as discussed above, the present invention lends itself to auction-style placement of advertising, in which bids are solicited for particular locations, times, or blocks of advertising. Auctions may be held, for example, on line, and may be broken down by media outlet type of ad (i.e. television, internet, etc.), product type of ad, or in any similar manner.

There are a myriad possibilities for the interaction between the properties resident in the vault of the present invention, the recommendation engine that recommends properties in the vault in the present invention, proposed creatives/advertisements, and the delivery of creatives/advertisements to prospective consumers. For example, the vault and or recommendation engine of the present invention may be under the control of a particular party, whereas the rules apply to certain advertisements or creatives, and/or the delivery engine that delivers the final creatives and/or advertisements, may be under the control of the same or a different party. Thus, the exemplary embodiments of the present invention discussed hereinbelow are discussed without regard to the controlling entity of each aspect of the invention, but those of ordinary skill in the pertinent arts will appreciate that different aspects of the present invention may be controlled by a single party or multiple parties up to and including a time of presentation of creatives or advertisements to a consumer or consumers. Thereby, the present invention may allow for practically unlimited numbers of interactions, such as wherein a particular product simply requests an advertisement for delivery at a certain time, and in a certain place, and involving any sponsor that falls within a requested category, such as sports, and the platform of the present invention may allow for the recommendation engine receiving the request to access the vault, find a sound byte or video of any party or parties meeting the requested criteria, and only that vault item may ultimately be delivered by the recommendation engine to a delivery engine. In such an embodiment, the delivery engine, which may be controlled by a different party, may bind a submitted creative or advertisement bound together with the vault item forwarded by the recommendation engine, assuming that the delivery engine is allowed to make such a binding in accordance with the rules relating to the vault item, which rules may be resident in a rules engine controlled by the same or yet another different party.

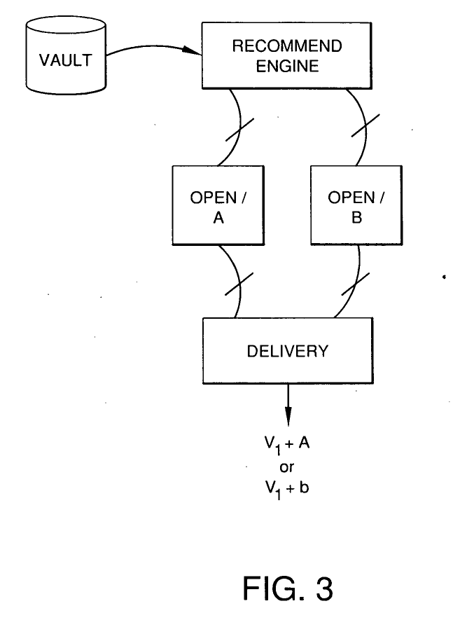

Thus, in a specific exemplary embodiment of the present invention herein referred to as a late binding embodiment, as illustrated in FIG. 3, a recommendation engine receives a request for vault items one and two, herein referred to as V1 and V2, to be produced with content A and B, respectively. It is noted, with respect to FIG. 3, that content A and B are independently delivered to a delivery engine that ultimately interfaces with consumers. Although content A and B may be delivered to the recommendation engine, as will be understood by those of skill in the art, FIG. 3 is of note in that content A and B need not be delivered to the recommendation engine in order for the recommendation engine to obtain the desired properties from the vault. Thus, continuing with the illustrative embodiment of FIG. 3, the recommendation engine obtains properties V1 and V2, presumably in accordance with the request made of the recommendation engine meeting any rules applicable to allow one to obtain the properties V1 and V2.

In this exemplary embodiment, content A and content B have been delivered, or will be delivered, to the delivery engine, and, responsive to the request, the recommendation engine delivers content V1 and V2 for binding with content A and content B, respectively. In such an embodiment, content A and content B may each respectively have created a “space” for the ultimate inclusion of content V1 and V2, respectively. Finally, in the illustrated embodiment, upon receipt of an advertisement request that would typically lead to the delivery of advertisement A, content V1 plus A is instead produced by the delivery engine. Similarly, in the event that an advertisement correspondent to B would typically be produced, the delivery engine of the instant embodiment will instead bind and deliver V2 plus B.

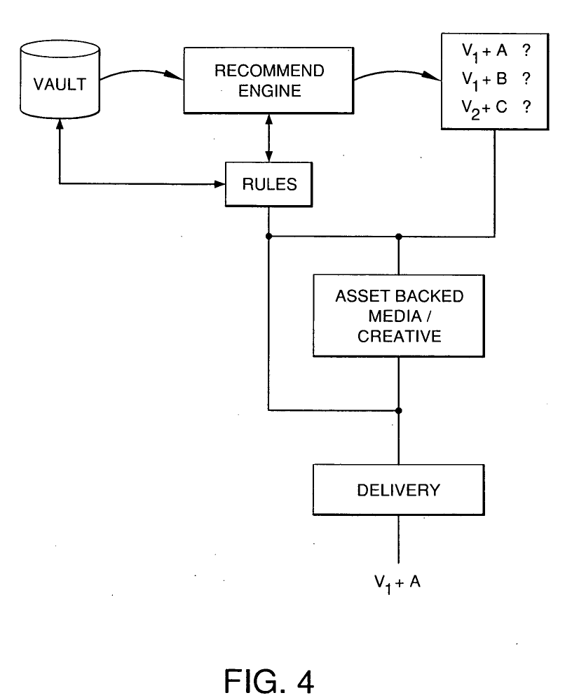

In an additional exemplary embodiment of the present invention illustrated in FIG. 4, and herein referred to as a prebind, the recommendation engine again receives a request for the association of content V1 and V2 with certain other content. However, in this embodiment and in contrast to the embodiment of FIG. 3, the recommendation queries, in part by accessing rules in a rules engine that govern the binding of V1 and V2 to particular other types of content, whether or not content V1 may be bound to content A, or content B, or whether content V2 may be bound to content C. In the event that one or more of such bindings are allowable in accordance with the recommendation request and the rules engine, such bindings are made to create what is herein referred to as asset backed media, which constitutes the union of the vault asset or vault content, with the content to which the union of the vault content was requested. In the illustrated embodiment of FIG. 4, this asset backed media is again passed through the rules engine to ensure compliance of the binding with the applicable rules of the rules engine, although those skilled in the art will understand that, in certain embodiments, this second application of rules from the rules engine may not be performed. Ultimately, the allowable union of the illustrated embodiment, which in this case is V1 plus A, is delivered to the delivery engine, which may subsequently deliver this union of V1 plus A to a consumer for whom advertisement A may be applicable. Of course, in this exemplary embodiment, content A may not be an advertisement, but may in fact be any type of creative, publication, media, or the like.

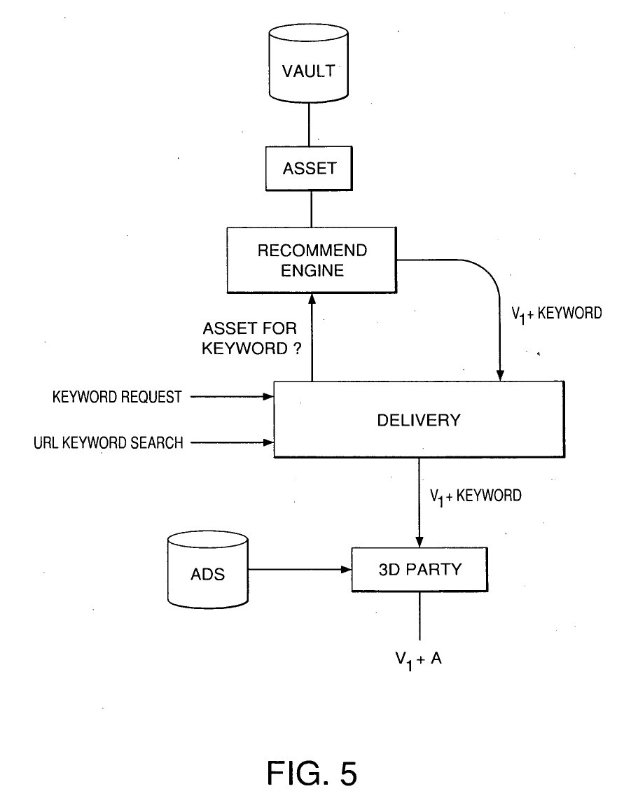

FIG. 5 illustrates an additional exemplary embodiment of the present invention, herein referred to as a sponsored page, or sponsored link, binding. In such an embodiment, for example, the generator of a page of content, or links of content, may wish that page or those links to be sponsored in the entirety by a relevant sponsor. Such a sponsor may, for example, make the effected page more relevant to consumers of the information on the page. In the embodiment illustrated in FIG. 5, the delivery engine delivers key word associations, rather than bound advertisements or creatives. The delivery engine illustrated further receives a key word request, and/or a URL key word search. The delivery engine then makes a request to the recommendation engine as to whether the recommendation engine has, located in the vault, an asset correspondent to the particular key word or key words or key word search of interest. The recommendation engine in this embodiment again accesses the vault and, if present, obtains the relevant asset or assets, which it subsequently binds with the requested key word or key words, respectively. This binding of vault asset V1 and key word A, as illustrated in FIG. 5, is then delivered to the delivery engine. The delivery engine then delivers asset V1 bound with the key word, either with the page or link or links, or to a third party entity. Either the delivery engine, or this third party entity, may then create the union of a secondary advertisement or creative with asset V1 to be produced to a consumer of the subject web page or link. It is almost goes without saying that, although the content V1 is dependent on the key word delivered to the delivery engine, such key word need not be delivered to the consumer, only the content, namely content V1, associated with that key word need be delivered to the consumer. Thereby, the present invention may be employed to add relevant sponsors to topical web pages on the internet. Likewise, relevant sponsors may be produced for publications, and relevant sponsored advertisements may similarly be produced on web pages and/or with publications.

For example, an entity publishing an online golf digest in the present invention may use the present invention to produce vault assets relating to Tiger Woods alongside the golf digest publication. Obviously, Tiger Woods may allow to reside in the vault certain assets related to Tiger Woods that are available for a fee, and/or other assets that are available at no fee in the event certain rules engine based criteria are met. Thus, in the aforementioned example, Tiger Woods may allow use of his likeness alongside the sited golf digest publication without payment of a fee, or with payment of a fee different from the fee Tiger Woods might receive for the use of content related to him in an advertising based embodiment. Likewise, the present invention may be used to produce relevant assets alongside or on the pages of, for example, online embodiments of newspapers and magazines.

Further, it is known in the existing art to engage in a myriad of different types of advertisement online. Two such advertisement types are: a search advertising model, in which a user undertakes to search for a good or service of interest and receives, as part of or as indicated with a search result(s), advertisements relevant to purchasing the good or service for which the search was made and/or to purchasing goods or services related to the good or service for which the search was made; and a display advertising model, in which a user is actively viewing a web site and receives, as part of the web site under review, advertisements for the purchase of goods or services relevant to the content of the web site under review. Needless to say, the former operates on the principal that, if a user searches for a good or service, he/she would like to buy that good or service, and the latter operates on the principal that if a user is interested enough in the content of a web site to view that web site, he/she is also likely interested in buying goods or services related to the content of that web site.

The display advertising model mentioned hereinabove is typically embodied as banner on a web site. For example, such banners may appear above, below, to the left, or to the right of the content being viewed, but typically do not impinge upon the content being viewed. The search advertising model mentioned hereinabove is typically embodied as advertisements/banners placed proximate to search results on the search results page responsive to the user search. For example, such advertisements may appear along a right hand side of a search results page, while the search results are displayed along the left hand side of the same search results page.

As discussed immediately above, it is necessarily the case that the correlations performed between the user's searched or viewed content and the advertisements provided will increase the relevance of, and thus the response to, the advertisements. However, such responses in the form of either clicks on the advertisements or purchases made through the advertisement link, once obtained at a particular rate, cannot be further improved by the relevance of the advertisements produced. Rather, the only manner to improve the response rate once relevant advertisements are produced is to improve the advertisements themselves based on the users viewing the advertisements.

The present invention provides such improved response advertisement through the provision of brand affiliations with the goods and services being advertised, as discussed hereinthroughout. As discussed, the present invention allows for the production of advertisements having brand sponsorship that is optimized to the market sought. That is, the brand sponsor selected for an advertised good or service is, though the use of the present invention, selected to best correspond to the characteristics of the purchaser sought by the advertisement.

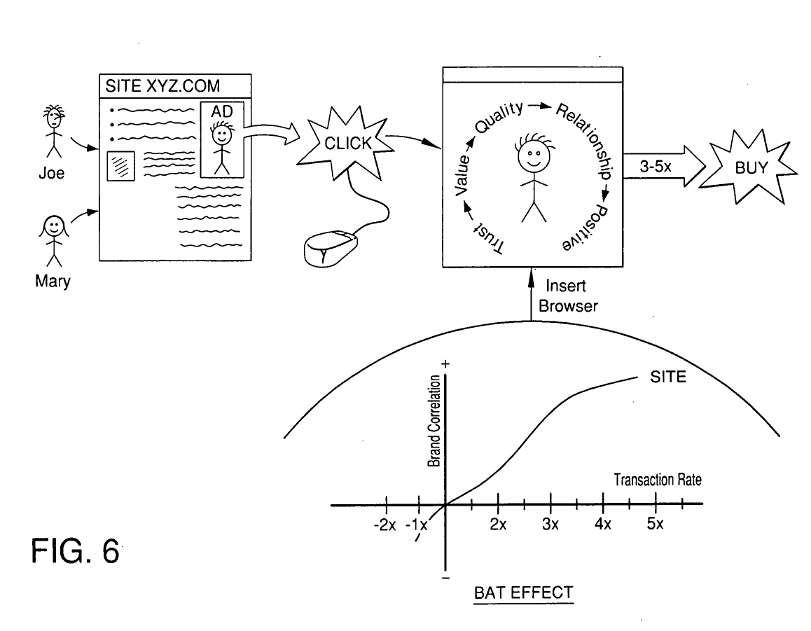

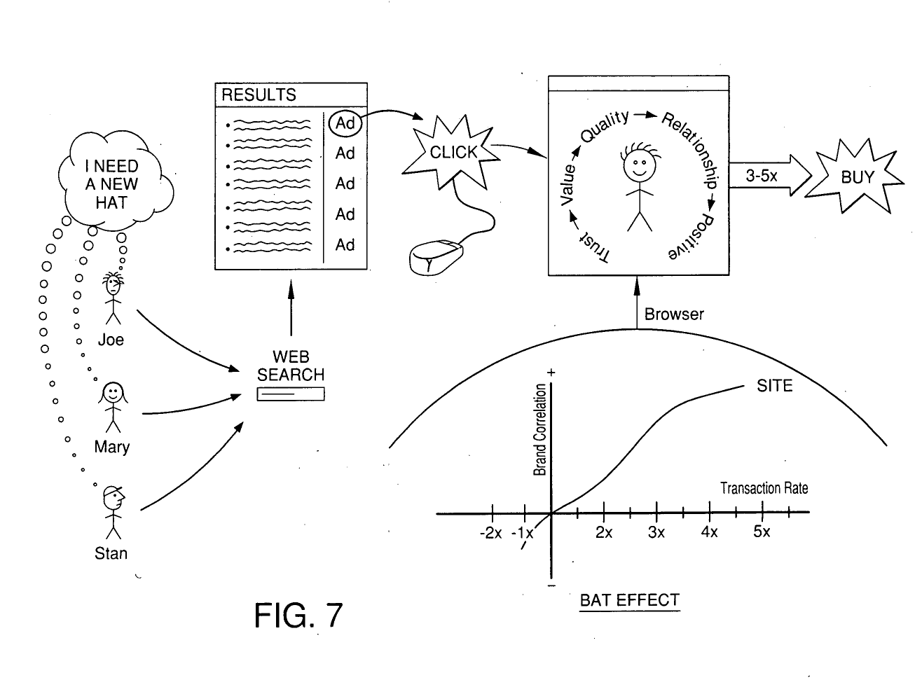

This effect is illustrated with respect to FIGS. 6 and 7. FIG. 6 illustrates the effect of the present invention with regard to a search advertising model, and FIG. 7 illustrates the effect of the present invention with respect to a display advertising model. In each Figure, a brand sponsor has been selected who will indicate, to the user for whom the advertisement is deemed most relevant, trust, quality, value, a relationship to the user, and/or an overall positive feeling. The sponsor is either selected by the advertiser in the present invention for inclusion with the subject advertisement, based on the profile of a desired purchaser and the characteristics of that sponsor as they relate to that profile, which relation is set forth or suggested by the present invention, or the sponsor is selected by the present invention for inclusion in or with the subject advertiser's advertisement based on a desired responder profile for the advertisement entered by the advertiser to the engine of the present invention.

As illustrated graphically in FIGS. 6 and 7, a positive correlation of a brand sponsor to a brand, which is necessarily also a correlation of a brand sponsor to those purchasers most interested in buying the subject brand, correlates positively to a increased transaction rate. In other words, to the extent the present invention provides brand affiliations, sponsorships, and the like that are well-suited to the sponsored brand, that brand will show an increase in the number of users who are shown that advertisement and that either click that advertisement or purchase that brand through that advertisement. It is estimated that the increase in the desired response rate in accordance with the use of the present invention may typically be a 3 to 5 times increase, based on the increased positive correlation between the sponsored brand and the brand sponsor provided by the present invention, although those skilled in the art will understand that more or less improvement in the transaction rate may occur based on the implementation of the present invention.

Thus, in accordance with the present invention, and as illustrated in FIGS. 6 and 7, an increased correlation of a brand sponsor to a sponsoring brand, and thus an increased correlation of a sponsoring brand to a desired purchaser's profile, is provided. This increased correlation generates an improved transaction rate in accordance with the present invention, for at least a search advertising model and a display advertising model.

The vault as described herein may also derive content from material produced or targeted for unconventional media channels and deliver the produced material along with associated branding or creatives. The inclusion of branding and/or creatives with the produced media may take the form of direct placement over the produced media or may, for example, be embedded, such as through the use of a product placement. The produced media may also not include a specific creative or branded item and may instead be used to increase the visibility of that which is featured in the produced content, whether that be, for example, a celebrity, a destination or lifestyle.

Distribution channels may include free web services, such as social networks and/or video sharing sites. The “produced material” may take any form, whether it be video, sound, text or any combination therefore, and may include a planned format. Produced material may generally include the use of a celebrity or a specific product or some combination of both, whether included visually of by reference.

In an embodiment of the present invention, produced material may be distributed for a select period of time over a select distribution channel. For example, a celebrity may shoot a trailer for the promotion of a movie which may be distributed for public viewing through a video sharing site for a discrete period of time. The distribution may be selectively targeted based upon the recommendation engine and delivery, including play duration, my be controlled by the present invention as well.

In a further embodiment of the present invention, the system may have interaction with specific agencies which have close relationships with celebrities and/or brands. These agencies may have direct interaction with the present invention and may not only use the present invention for the creation and placement of creatives, for example, but also provide for the populating of various assets and associated attributes. In many ways, such an agency may utilize the present invention to not only support traditional advertising practices, but to build its own in-house brands and celebrities. In the case of celebrities, this “self-promotion” may bolster asset values globally for users of the present invention and, more directly, for the agency who is closely associated with that celebrity. In all, the direct use of the present invention by an agency or like body adds value to the vault and builds the associations afforded the participating assets.

As will be apparent to those skilled in the art, the engines within the endorsed advertising engine of the present invention may draw on any number of communication access points and media sources, including wired and wireless, radio and cable, telephone, television and internet, personal electronic devices, satellite, databases, data files, and the like, in order to increase content in the vault, contribute content for intelligent selection of brand associations, and best allow for recommendations and delivery.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

1. A creative composition engine, comprising:
at least one vault comprising media assets;
at least one derivation engine associated with said at least one vault, wherein said at least one derivation engine derives ones of the media assets from material produced for at least one unconventional media channel;
a receiver for receiving at least one request for a creative associated with the at least one media asset produced for the unconventional media channel; and
a delivery engine that generates at least the at least one media asset produced for the unconventional media channel and the associated requested creative;
wherein the at least one media asset and the associated requested creative are bound for delivery as a creative to a consumer.

2. The engine of claim 1, wherein the creative comprises an advertisement.

3. The engine of claim 1, wherein the creative comprises entertainment.

4. The engine of claim 1, wherein the media asset comprises one selected from the group consisting of a movie, a television show, a music video, a music audio, a still photo, a video, a sporting event, a text message, a symbol, an emblem, a tagline, a press release, a publication, a web link, and a media capable of re-purposing.

5. The engine of claim 1, wherein said at least one vault further comprises a plurality of rules governing the creative.

6. The engine of claim 1, wherein said at least one vault further comprises a plurality of rules governing acceptable ones of the requested creative.

7. The engine of claim 1, wherein said at least one vault further comprises a plurality of rules governing use of the media assets.

8. The engine of claim 1, further comprising an advertising server for delivering the creative to the consumer.

9. The engine of claim 8, wherein said advertising server is apart from at least one of said vault and said receiver.

10. The engine of claim 8, wherein said advertising server further comprises one of a pre-binding, a binding at request, and a late stage binding of the at least one media asset into the creative.

11. The engine of claim 1, wherein said at least one vault further comprises information associated with the media assets.

12. The engine of claim 11, wherein the information associated comprises metadata.

13. The engine of claim 1, wherein said at least one vault further comprises payment schema associated with ones of the media assets, and wherein ones of the payment schema differ from other ones of the payment schema.

14. The engine of claim 1, wherein said receiver comprises a recommendation engine.

15. The engine of claim 1. wherein one or more of the media assets has associated therewith a profile.

16. A creative composition engine, comprising:
at least one vault associated with at least one computerized memory comprising media assets;
at least one derivation engine associated with at least one processor and said at least one vault, wherein said at least one derivation engine derives ones of the media assets from material produced for at least one unconventional media channel;
a receiver for receiving over a computerized communications network at least one request for a creative associated with the at least one media asset produced for the unconventional media channel; and
a delivery engine that generates at least the at least one media asset produced for the unconventional media channel and the associated requested creative;
wherein the at least one media asset and the associated requested creative are bound for delivery as a creative to a consumer over the computerized communications network.

17. The engine of claim 16, wherein the creative comprises an advertisement.

18. The engine of claim 16, wherein the creative comprises entertainment.

19. The engine of claim 16, wherein the media asset comprises one selected from the group consisting of a movie, a television show, a music video, a music audio, a still photo, a video, a sporting event, a text message, a symbol, an emblem, a tagline, a press release, a publication, a web link, and a media capable of re-purposing.

20. The engine of claim 16, wherein said at least one vault further comprises a plurality of computer programmable rules governing acceptable ones of the requested creative.
